(19) United States
(12) Patent Application Publication
(10) Pub. No.: US 2004/0073530 A1
(43) Pub. Date: Apr. 15, 2004

(54) Information management via delegated control

(76) Inventors: David Stringer-Calvert, Santa Clara, CA (US); Patrick Lincoln, Woodside, CA (US); Steven Dawson, Menlo Park, CA (US)

Correspondence Address: Moser Patterson & Sheridan, Suite 100, 595 Shrewsbury Avenue, Shrewsbury, NJ, 07702, US

(21) Appl. No.: 10/149,079

(22) PCT Filed: Dec. 6, 2000
(86) PCT No.: PCT/US00/42670

(51) Int. Cl. G06F 7/00

(52) U.S. Cl. 707/1

(57) ABSTRACT

The present invention is directed to an information management system (“IMS”) which utilizes delegated control (FIG. 1) over a dataset to overcome a number of the problems associated with existing IMSs. Delegated control is the transfer, generally temporary, of at least partial control over the dataset (50) from a delegating system (100) to a delegate system (200). The delegating system has full control of the dataset, but declines to exercise that authority in regard to at least a portion of the dataset while authority over that portion of the dataset is delegated. Thus, any dataset modification request received from a reqestor (300) system that wants to modify the dataset, and is not the delegate or delegator, will be refused.

This application claims the benefit of U.S. provisional application No. 60/247184 incorporated herein by reference in its entirety.

### FIELD OF THE INVENTION

The field of the invention is computer based information management systems.

### BACKGROUND OF THE INVENTION

The rapid growth in the use of information-intensive applications is placing huge burdens on information providers as they struggle to keep their information systems capable of coping with the demands of information consumers. For applications that involve information flowing largely from providers toward consumers, such as web page viewing and streaming media, techniques such as content replication and caching are commonly used to reduce server load and alleviate network congestion. Solutions based on these techniques are commonly offered by content delivery networks, which manage the distribution of content from providers' central servers, usually to points in the network intermediate between the providers and consumers. Such solutions help information providers offer better performance and higher reliability to information consumers.

The global information infrastructure is not, however, simply a conduit for electronic content delivery, but is becoming increasingly important as a vehicle for commerce. Electronic commerce, often referred to as e-commerce, requires careful attention to the design of providers' information management systems (IMSs) and the mechanisms through which it interacts with other IMSs. Although the same can be said for content delivery, it is even more important for e-commerce, which involves much more two-way communication between providers and customers than does content delivery. Moreover, this two-way communication frequently constitutes transactions, which necessarily involve the recording and modification of information at the provider (server) side as well as the customer (client) side.

In terms of transaction processing, the current Internet suffers from a significant bottleneck, in that transactions cannot be distributed as easily as content can, but normally must be processed at a provider's central server. The essential problem is that read-only data (data that is not modified) may be replicated and cached without loss of consistency, but data that may be updated (written) cannot easily be kept consistent when replicated. Thus, while content delivery networks can utilize data distribution sites near clients to speed the delivery of much of a provider's information, such as marketing materials and catalogs, all the clients must connect with the provider's actual server to conclude transactions. This not only increases the processing and network load on the server, but also causes significant contention among clients for locks when data on the server needs to be updated. Wait time for release of locks is problematic in many existing file systems and database management systems (“DBMSs”) in which locking and unlocking of records/files to be modified is a method used to maintain data integrity. The longer an item is locked, the more likely it is the some other client/user will want to access the item. Although limited access may be provided such that a non-locking user/client may read the contents of the item, modifying the contents must wait until the lock is released. As a result, the transaction server becomes a severe bottleneck in the information system architecture.

The problem can be alleviated somewhat if the central transaction server is implemented as a distributed database, where the data maintained by the central server is partitioned and distributed among multiple database servers. However, distributed databases are costly to design, implement, and maintain. Moreover, they are difficult to reconfigure and are thus best suited to reasonably static environments, akin to physical distribution networks made up of warehouses in fixed locations. There is a need in the art for scalable, high-performance data management techniques that will fully realize the benefits of e-commerce in the dynamic environment of the Internet.

### SUMMARY OF THE INVENTION

An information management system (“IMS”) as used herein comprises one or more computers and one or more software applications interacting to store information. The entire set of information stored by the IMS may be referred to as the “global dataset”. The global dataset may be divided into subsets. Each subset may in turn be viewed as a dataset which is itself divided into subsets. As an example, an IMS may comprise a plurality of relational databases with the contents of all the databases making up the global subset, but each database may also be viewed as containing a dataset broken up into subsets/tables, and each table may also be viewed as a dataset containing multiple subsets/records.

It is important to note that the IMS may or may not comprise applications which are typically thought of as database servers. As an example, an IMS may comprise one or more file servers, with files contained on all of the file servers making up the global dataset, and the files on a particular file server making making up a data subset. Where the IMS comprises a plurality of relational database servers, various data subsets may be divided between the plurality of database servers.

The present invention is directed to an information management system (“IMS”) that utilizes delegated control over a dataset to overcome a number of the problems associated with existing IMSs. Delegated control is the transfer, generally temporary, of at least partial control over the dataset from a delegating system to a delegate system. Transfer may be of a representation of the data over which authority is delegated. The delegating system (hereinafter sometimes simply “delegator”) is a system that has full control of the dataset but refuses to exercise that authority in regard to at least a portion of the dataset while authority over that portion of the dataset is delegated. Thus, any dataset modification request received from a requestor system that wants to modify the dataset and is not the delegate or delegator will be refused unless accompanied by authority from the delegate.

As an example, in an IMS comprising a file server which utilizes file locking, a file may be locked by an application ruing on a first user's system. A second user may want to modify the file while it is locked. In such a situation, the file server may be viewed as a delegator which has delegated its authority over the dataset/file to a delegate by locking the file and preventing modification of the file until the delegate is finished with the file unless the delegate authorizes modification of the file while it is locked. This differs from existing systems in which the requester must wait until the lock is released by the delegate or overridden by the delegator before updating the file because the delegate can authorize modification of the file while it is locked.

In another example, an IMS may comprise an airlines database server/delegator and two or more ticketing agency database servers (the delegate and requestor). A particular ticketing agency (the delegate) may want to “lock” the records associated with a block of seats on a particular flight, possibly because it has received a tentative reservation for such tickets, or because it receives a discount from the airline/delegator by purchasing the entire block. If a second ticketing agency (the requester) has a customer which wants to buy a ticket included in the block, the airline/delegator is unable to sell it while it is locked by the first ticketing agency/delegate. Utilizing the methods and devices disclosed herein, the request to purchase the ticket may be responded to by the airline/delegator informing the second ticketing agency/requestor that that particular ticket is “locked” by the first ticketing agency/delegate. The second ticketing agency/requestor may then communicate with the first ticketing agency/delegate in order to authorize the airline/delegator to sell the ticket to the second ticketing agency/requestor.

In an alternative view, the present invention is directed to an IMS in which authority over a dataset is temporarily delegated by a primary data server to a first secondary data server in a manner which allows a second secondary data server to modify the dataset while the first secondary data server retains the delegated authority, but only with the approval of the first secondary data server. Thus, the second secondary data server cannot make modifications to the dataset on its own, and cannot “go over the head of” or bypass the first secondary data server by communicating solely with the primary data server. Also, because it has delegated its authority over the dataset, the primary data server cannot itself modify the dataset without approval from the first secondary data server as long as the first secondary data server retains the delegated authority.

In another alternative view, the present invention is directed to an IMS that distributes temporary control over requests to update from a first processor to at least a second processor. By distributing certain transactions, contention for cycles on the first processor is decreased. In a particular embodiment of such an IMS, the system comprises a storage device having at least one item of data to be modified. A first processor assigns at least partial temporary control over update access of the item to a third processor. The third processor will control requests to modify the item of data, and is programmed to grant an authorization to modify the item. In one variation of the inventive subject matter, the third processor sends the authorization to modify to the first processor, and the first processor updates the item of data on the storage device. In another variation, the third processor directly updates the item of data on the storage device. In another variation, the third processor sends the authorization to modify to a second processor and the second processor updates the item of data on the storage device.

In yet another alternative view, a plurality of computational nodes are communicating within a network and attempting to access a set of resources. The set of resources may include printers, storage devices, memory or any other resource. It is also contemplated that the resources may include data, and access to such data may comprise the privileges of reading, writing, updating, and deleting. Other envisioned resources include articles of commerce which may be added to an electronic shopping basket. In this view, one or more of the nodes functions as a delegator of authority over a subset of the resources. The node that functions as a delegator delegates authority over the subset of resources to at least one node who functions as a delegate. At least one node functioning as a requestor makes a request to access one or more of the resources, and in response to the request, the node functioning as the delegate executes a transaction committing at least a portion of the subset of resources to the requestor. Execution of the transaction may also comprise electronically transmitting payment information. The transaction is executed without interaction with the delegator.

It is contemplated that the IMSs described herein decrease bottleneck, overloading, and reliability problems by allowing for the dynamic distribution of data subsets among secondary servers in a less problematic manner than existing systems. In particular, problems relating to a second secondary server updating a data item within a subset of the core dataset reserved by the first secondary server are minimized.

### BRIEF DESCRIPTION OF THE DRAWING

FIG. 1 is a schematic view of an IMS according to the inventive subject matter.

FIG. 2 is a schematic view of an IMS according to the inventive subject matter as it may be used in an airline-ticketing agency context.

FIG. 3 is a schematic view of an IMS according to the inventive subject matter as it may be used in a shared file system context.

FIG. 4 is a schematic view of an IMS according to the inventive subject matter as it may be used in an e-commerce “shopping basket” context.

### DETAILED DESCRIPTION

As used herein, “delegated control” is the transfer, generally temporary, of at least partial control over a data set from a delegating system to a delegate system. The term “delegated control” is used interchangeably with the term “delegated authority”. The delegating system (hereinafter sometimes simply “delegator”) is a system which has full control of the data set but refuses to exercise that authority in regard to at least a portion of the data set while authority over that portion of the data set is delegated. As used herein the term “control over” an item of data or a dataset indicates the capability to lock, read, modify, delete, and put data or at least to allow one of these capabilities. In the preferred embodiment, control is the capability to allow, authorize, or effect a modification to the item of data. Other contemplated embodiments of control include having the capability to lock and unlock the data item.

Delegating Control/Authority

Delegation of control is generally done by a node functioning as a delegator. The delegator may delegate control to at least one node functioning as a delegate. One or more of the delegate nodes may further delegate to other delegate nodes. It is contemplated that delegates may exchange authority/control with each other over a subset of the resources previously delegated.

Delegation may be based upon a request from the delegate or a computation that utilizes factors such as processor load, communication bandwidth, resource availability, and resource contention. Delegation may also be dynamically adjusted, such dynamic adjustment based on a plurality of factors.

Referring to FIG. 1, an IMS 10 utilizes delegated control over a dataset 50. In the IMS of FIG. 1, a delegator 100 initially has full control over the dataset 50. At some point after the establishment of dataset 50, control over at least a portion of the dataset such as subset 51 is delegated to the delegate 200. While delegate 200 is acting as the delegate of delegator 100, delegator 100 refrains from exercising its full authority over data subset 51. Thus, any request to update the data subset 51 received by delegator 100 from requestor 300 will be refused unless delegate 200 authorizes the update. Thus, the delegator 100 has delegated control over the dataset 50 to the delegate 200.

Ticket Sales

It is contemplated that IMS 10 may be advantageously used in a number of contexts. One such is where an airline wants to outsource ticket sales to two or more other companies. In so doing, the airline need not obtain or maintain the technical staff and equipment necessary to successfully implement a state of the art eCommerce web site. Nor must the airline establish the special relationships with banks and other financial institutions required for providing consumers with the myriad purchasing options they've come to expect. Yet another advantage is the decrease in likelihood of a successful “hacker” completely disrupting business because ticket sales are handled by multiple systems, that the airline's computer systems may be insulated from the outside world because direct interaction with purchasers may be eliminated, and failure of the airlines systems does not necessarily interrupt ticket sales as authorization by the airline's systems is not required.

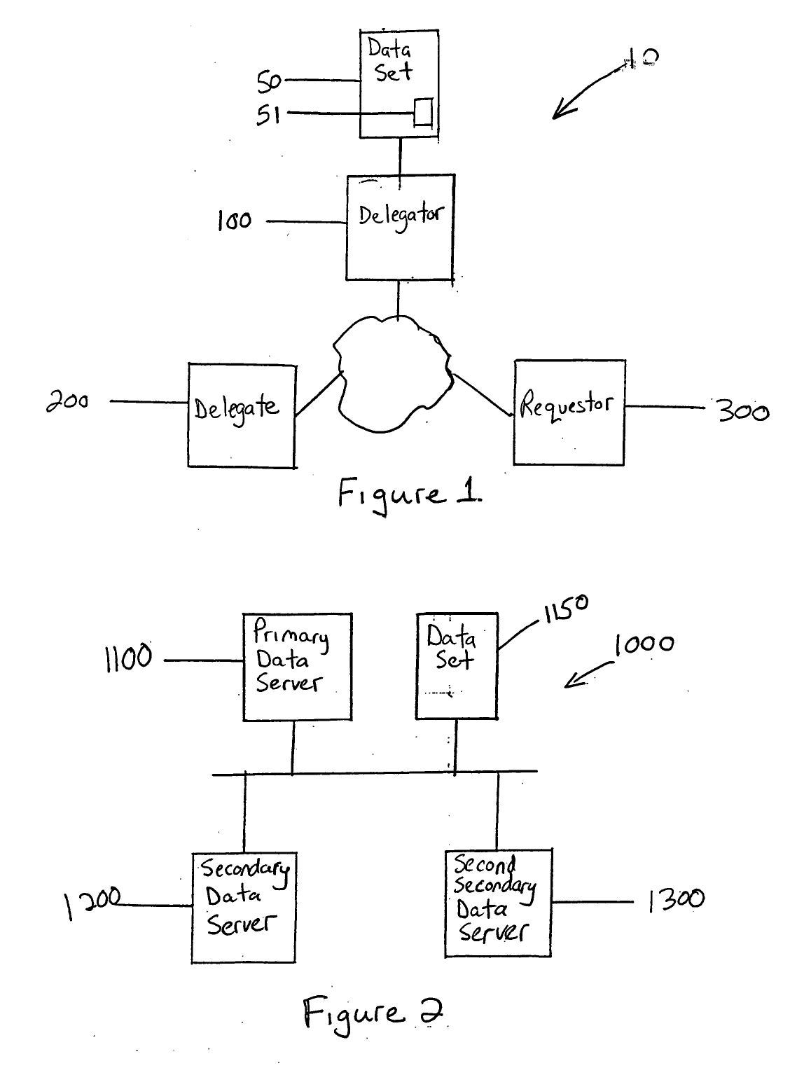

In FIG. 2, an IMS 1000 being used in an airline and ticketing agency context includes an airline DBMS/primary data server 1100 which initially has control over a core data set 1150 and subsequently delegates at least some of that control over the data set 1150 to a first ticketing agency DBMS/secondary data server 1200 in a manner which allows a second ticketing agency/secondary data server 1300 to modify the data set while the first secondary data server 1200 retains the delegated authority, but only with the approval of the first secondary data server 1200. Thus, the second secondary data server 1300 cannot make modifications to the data set 1150 on its own, and cannot “go over the head of” or bypass the first secondary data server 1200 by communicating solely with the primary data server 1100. Also, because it has delegated its authority over the data set, the primary data server 1100 cannot itself modify the data set 1150 without approval from the first secondary data server 1200 as long as the first secondary data server 1200 retains the delegated authority.

The following scenario is one which may be possible using the IMS of FIG. 2, and in which the sale of a ticket corresponds to an update of one or more data records: An airline creates a database relating to flight information and seat availability. A first ticketing agency reserves a block of seats so that it is primarily responsible for the sales of those seats and consequently is primarily responsible for the data records corresponding to those seats. A traveler contacts a second ticketing agency and indicates that he/she wants to purchase a particular seat. The second ticket agency attempts to sell the ticket. The airline informs the second ticketing agency that the first ticketing agency currently has control over the seat. The second ticketing agency then contacts the first ticketing agency and works out an agreement with the first ticketing agency that the relevant ticket will be sold to the traveler. The first ticketing agency then informs the airline that the ticket is to be sold to the traveler.

Data server 1100 is preferred to comprise a data controller 1110 and storage device 1120 in addition to data set 1150. Data server 1100 may consist of a single computer utilizing a single CPU/microprocessor executing a database server process as the data controller 1110 and having a hard disk as storage device 1120. Alternatively, the data controller 1110 may comprise a computer or group of computers acting in concert with the computer or group of computers with a separate computer or group of computers making up storage device 1120. Similarly, secondary servers 1200 and 1300 may comprise a single computer utilizing a single CPU/microprocessor, a single computer utilizing multiple CPUs/microprocessors, or a group of computers each of which utilizes one or more CPUs/microprocessors.

Storage device 1120 maybe any storage medium capable of housing electronic data including a CD, tape, ′or floppy disk. In a preferred embodiment, the storage device 1120 comprises a series of high capacity disk drives of at least 1 terabyte. However, contemplated storage devices may be any logical size including at least 10 gigabytes, at least 100 gigabytes, and at least 1 terabyte. It is preferred that the storage device 1120 be located at least 1 km. from data controller 1110, however it is also contemplated that the storage device 1120 is located at least 0.5 km., at least 0.25 km. or at least 0.1 km. from the data controller 1110. Secondary data servers 1200 and 1300 may also incorporate storage devices with such storage devices being the same as or similar to those of each other and that of primary data server 1100.

The CPUs/microprocessors of the primary and secondary data severs may be any known processor performing at any speed capable of receiving an instruction, processing an instruction, and sending an instruction, however CPUs/microprocessors operating at a speed of at clock speed of at least 1 GHz are-preferred.

In preferred embodiments the primary server and secondary servers are individual computers or groups of computers connected via a network.

In alternative embodiments, various degrees of control over data subsets, with or without the data itself may be delegated to the first secondary data server 1200. Thus, in one instance a complete copy of a subset of the data over which the first secondary data server 1200 has delegated authority may be maintained on the first secondary data server 1200 such that requests for records contained in the subset can be satisfied by the first secondary data server 1200. In another instance, an incomplete copy of a subset of the data may be maintained on the first secondary data server 1200 such that the first secondary data sever only has enough data to determine whether or not to authorize updates requested by the second secondary data server 1300, but not enough to satisfy any query relating to the subset of data over which it has delegated authority.

The mechanisms for updating the core data set may also vary between embodiments. In one instance updates requested by the second secondary data server 1300 may be communicated first to the first secondary server and subsequently passed on to the primary data server 1100 by the first secondary data server 1200. In such an instance the authorization to update the subset of data over which the first secondary data server 1200 has control may be implicit in the fact that the request for an update received by the primary data server 1100 is coming from the first secondary server. In another instance, a request to modify data may be received by the primary data server 1100 directly from the second secondary data server 1300. In such an instance, in order for the update request communicated by the second secondary data server 1300 to be acted upon by the primary data server 1100, the request must either contain an authorization previously received from the first secondary data server 1200, or the request must be preceded by a communication between the first secondary data server 1200 and the primary data server 1100 in which the first secondary data server 1200 provides the required authorization directly to the primary data server 1100.

If the primary data server 1100 has a reason to update a subset of data while control of the subset has been delegated to the first secondary data server 1200, authorization from the first secondary data server 1200 must be obtained prior to the update taking place. Although it is preferable that in such an instance the primary data controller communicate directly with the first secondary data server 1200, alternative embodiments may require that the required authorization, or the request for such an authorization be passed through the second secondary data server 1300 or in some other manner than directly from and to the first secondary data server 1200.

File Sharing

Another contemplated advantageous use of the methods and devices disclosed herein is in relation to a file server which utilizes file locking. In such an IMS, a file may be locked by an application running on a first user's system. A second user may want to modify the file while it is locked. In such a situation, the file server may be viewed as a delegator which has delegated its authority over the dataset/file to a delegate by locking the file and preventing modification of the file until the delegate is finished with the file unless the delegate authorizes modification of the file while it is locked. This differs from existing systems in which the requestor must wait until the lock is released by the delegate or overridden by the delegator before updating the file because the delegate can authorize modification of the file while it is locked.

In FIG. 3, a preferred IMS 2100 generally comprises a storage device 2200, a data item 2210, a first processor 2310, a second processor 2320, and a third processor 2330. In a file sharing context, first processor 2310 and storage device 2200 may make up a file server and data item 2210 may be a file stored on/in the file system. The third processor 2330 is to be the delegate and may be a word processor that is running on a computer other than the file server. The second processor is the requester. A delegate may be selected to handle a requestor's request at least partly based upon an assessment of connectivity between the requestor and the delegate. The first processor/file server 2310 may assign control of updates of data item/file 2210 to the third processor/delegate 2330 by “locking” data item/file 2210. However, the locking contemplated provides delegated control over data item/file 2210 in that the third processor/delegate 2330 can authorize modifications to the file while it is “locked”. Thus the second processor/requestor 2320 may actually be able to have data item/file 2210 updated by obtaining an appropriate authorization from the third processor/delegate 2330. This differs from previously known IMSs in which the second processor/requestor 2320 is generally unable to influence when the data item/file 2210 will be unlocked or to effect changes to the data item/file 2210 prior to its being unlocked.

In contemplated embodiments, the first processor 2310 obtains a copy of the data item 2210 from the storage device 2200, and sends the copy of the data item to the second processor 2320. The second processor 2320 receives an instruction to modify the copy of the data item. In response to the instruction to modify, the second processor 2320 sends a request for authorization to the third processor 2330. From the third processor 2330, data travels one of at least three different paths to the storage device 2200. The difference between the three basic variations is a path data will travel from the third processor 2330 to the storage device 2200.

In a first path A, data travels from the third processor 2330 to the first processor 2310 to the storage device 2200. In the first path A, the second processor 2320 sends a changed copy of the data item to the third processor 2330 in addition to the request for authorization. The third processor 2330 analyzes the request for authorization, and in response sends an authorization and the changed copy of the data item. The first processor 2310, responding to the authorization, updates the data item 2210 with the changed copy of the data item.

In a second path B, data travels from the third processor 2330 to the storage device 2200. In the second path B, the second processor 2320 sends a changed copy of the data item to the third processor 2330 in addition to the request for authorization. The third processor 2330 analyzes the request for authorization, and in response updates the data with the changed copy of the data item.

In a third path C, data travels from the third processor 2330 to the second processor 2320. The third processor 2330 analyzes the request for authorization, and in response the third processor 2330 sends an authorization to the second processor 2320. The second processor 2320 updates the data with the changed copy of the data item.

The features of storage device 1120 previously discussed apply equally well to storage device 2100. Similarly, previously discussed features of data server CPUs apply equally well to processors 2310, 2320, and 2330.

Shopping Baskets

Another contemplated advantageous use of the methods and devices disclosed herein is in the context of an IMS for e-commerce applications such as online shopping and similar forms of electronic transactions. Such an IMS makes it possible, for example, for a vendor to distribute its primary server's transaction processing load to one or more additional transaction servers, thereby alleviating the potential bottleneck of a centralized transaction server. The advantages of such a system are many, including a more scalable transaction processing capability for the vendor, reduced sensitivity of the overall system to individual system failures, and improved shopping experiences for the customers.

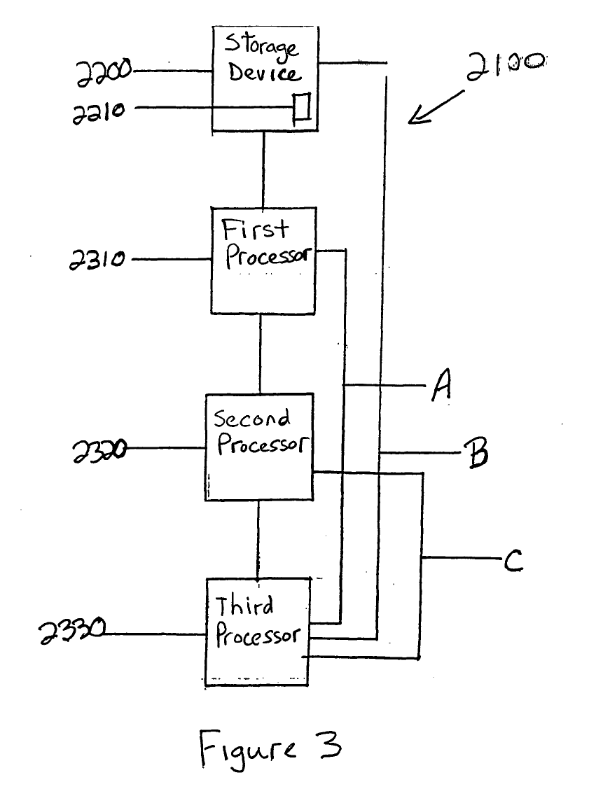

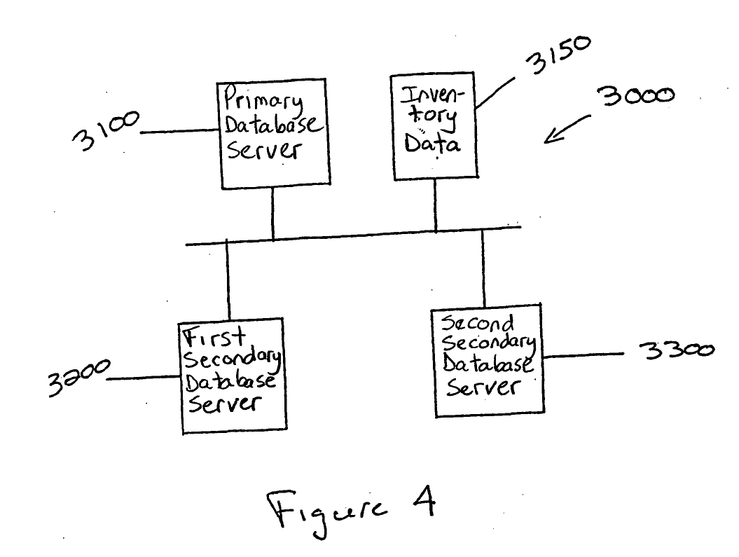

In FIG. 4, an IMS 3000 used in an online shopping context includes a primary database server 3100 which has initial control over a product vendor's inventory data 3150 and which delegates control over portions of that data to at least a first secondary database server 3200. While the delegated authority remains effective, neither the primary server 3100 nor any second secondary server 3300 may exercise control over the data delegated to the first secondary server 3200 without the consent of the first secondary server 3200. The primary server 3100 may delegate control over different portions of data to different secondary servers (not shown). It may even delegate different degrees of partial control to more than one secondary server.

In one possible scenario, the primary server may be the inventory database of vendor of appliances such as toasters and washing machines. This database may contain a record such as “Toaster, Model T: 100”, representing the fact that the vendor has a stock of 100 Model T toasters. Two of the vendor's electronic retail sites, R1 and R2, begin offering Model T toasters for sale. To speed the completion of toaster sales transactions, the primary server may delegate partial control over the Model T toaster record in its database to the (secondary) server of each retail system by granting R1 authority to sell 25 toasters and granting R2 authority to sell 35 toasters. The primary server may retain authority over the remaining 40. A customer could then browses site R1, becomes interested in the Model T toaster, and decides to purchase one. Because R1 may have authority over a guaranteed stock of toasters, R1 can complete the transaction without the customer having to communicate at all with the primary server, which can significantly speed the completion of the transaction from the customer's point of view. To fulfill the order, R1 may issue the order directly to the warehouse/distributor or may relay the order through the primary server, but in either case, the customer may not encounter any added delay in the transaction. Should R1 exhaust its authority to sell toasters (e.g., by completing transactions totaling 25 toaster sales), it may request additional or extended authority from either the primary server or any secondary server with authority for a portion of the data representing the same toaster model.

The above scenario illustrates one preferred embodiment of an IMS with delegated control, in which a primary server delegates partial, apportioned control over data to one or more secondary servers. In an additional contemplated embodiment, a delegator may delegate overlapping control to more than one delegate, where the delegates negotiate among themselves for effective authority over the item of shared control.

In the context of shared control, it is contemplated that the delegates utilize secret sharing techniques to secure their shared delegated control. “Secret sharing” refers to methods by which a group may collectively maintain a secret, but where that shared secret remains unknown to any of the individual members. Typically, a collective secret is maintained by individual members of a group each holding a piece of information unknown by all the others. Generally, a plurality of these individual pieces of information is required to reconstitute or unlock the collective secret. Such a collective secret can be shared by a group of any size, and the individual secret pieces can be chosen such that a subset of any desired size can collaborate to unlock the shared secret. For example, a secret might be shared among a group consisting of five members such that any three of them may collaborate to unlock the shared secret. Another secret might be shared by the same five members such that any two of them may collaborate to unlock it.

In another embodiment, the delegator may be the intiator of delegated control, rather than delegating upon request from potential delegates. For example, in an e-commerce environment, a primary inventory control server may initiate apportioned delegation to a set of secondary servers. In a related embodiment, the primary server may utilize information specific to the respective secondary servers when determining how to delegate, whether the delegation is delegator initiated or delegate initiated. In an e-commerce setting, such information could include transaction histories; customer preferences; demographic information; location; date; time of day; and server computational power, storage capacity, and network bandwidth.

In a further preferred embodiment, the IMSs comprise all or part of an “edge” network. An edge network is one that includes more than 20 nodes, at least several of those nodes being physically separated from each other by a distance of at least 1 km, and where the edge network nodes are communicatively coupled via data channels that are faster by at least an order of magnitude than the speed of connection between the edge nodes and at least one or more non-edge network nodes. For example, a typical edge network might be a group of geographically distributed Internet servers connected to each other by relatively high-speed lines (such as dedicated leased lines). A “private edge network” is an edge network whose nodes are under the management and control of a single entity (such as a corporation or partnership, for example). Many edge networks have arisen or been constructed out of a desire to provide improved network infrastructure for delivering content across the Internet to multitudes of geographically diffuse end-users. (See, for example, the methods of Digital Island at http://www.digisle.net/ and Akamai at http://www.akamai.com.) However, current approaches do not address the essential e-commerce function of transaction processing, since data replicated and cached at edge nodes is difficult to keep consistent in the presence of updates. The use of the delegated control methods and devices disclosed herein will greatly extend the applicability of edge networks in the field of e-commerce.

Thus, specific embodiments and applications of IMSs have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed is:

1. A method of controlling access to a set of resources using a plurality of computational nodes communicatively coupled via a network, said method comprising:
delegating authority automatically over a subset of the resources by a delegator to at least one delegate, said delegator comprising at least one of the nodes and said delegate comprising at least one of the nodes;
requesting, by a requestor comprising at least one of the nodes, access to a desired one or more of the resources; and
executing a transaction committing at least a portion of the subset of resources to the requestor in response to said request for access, by authority of said delegate and without first requiring an additional interaction with the delegator.

2. The method of claim 1 wherein the delegating of authority is performed by the delegator in response to a request from the delegate.

3. The method of claim 1 wherein the delegating of authority is performed by the delegator based upon a computation involving one or more quantities selected from the group comprising: processor load, communication bandwidth, resource availability, and resource contention.

4. The method of claim 1 further including dynamically adjusting the authority delegated to the delegate.

5. The method of claim 4, wherein the authority delegated to the delegate is temporally limited.

6. The method of claim 4, wherein dynamically adjusting the authority delegated includes increasing and decreasing the subset of resources over which authority was previously delegated to the delegate, based at least partly upon a computation involving one or more quantities selected from the group comprising: processor load, communication bandwidth, resource availability, and resource contention.

7. The method of claim 1 wherein the delegating of authority further includes delegating authority over the subset of resources from one or more higher-level delegators each comprising at least one of the nodes to the delegator.

8. The method of claim 1 wherein the delegating of authority further includes delegating authority over a plurality of subsets of the resources to a corresponding plurality of delegates.

9. The method of claim 8 wherein one or more of the delegates automatically delegates authority to another one or more of the delegates over a subset of the resources previously delegated to said one or more of the delegates.

10. The method of claim 9, wherein two or more of the delegates exchange authority with each other over a subset of the resources previously delegated among said two or more of the delegates.

11. The method of claim 1, further including automatically forwarding to the delegate over the network, by the delegator, the requestor's request for access.

12. The method of claim 1 wherein the requesting comprises one or more communications over the network between the requestor and at least one of the delegates, and does not include interaction over the network with the delegator.

13. The method of claim 1 wherein the delegate is part of an edge network.

14. The method of claim 1 wherein the delegate node and the requester node have a peer-to-peer communication relationship within the network.

15. The method of claim 1 wherein the delegate is selected to handle the requestor's request at least partly based upon an assessment of connectivity between the requestor and the delegate with respect to one or more metrics selected from the group comprising: connection bandwidth, connection latency, connection availability, geographical network distance and topological network distance.

16. The method of claim 1 wherein the subset of resources comprises data, and the requested access comprises an access privilege selected from the group comprising:
reading, writing, updating, and deleting.

17. The method of claim 16 further including:
transferring, from the delegator to the delegate, a representation of the data over which authority is delegated; and
providing access for the requestor, via the delegate nodes, to the data committed to the requester in response to the request.

18. The method of claim 1 wherein the subset of resources comprises articles of commerce, and the requested access comprises acquiring the desired article.

19. The method of claim 18, wherein the requesting includes an interaction over the network between the requestor and the delegate utilizing an electronic shopping basket user interface to specify the desired articles.

20. The method of claim 18 further including, subsequent to the executing, transferring the desired article to a recipient specified by the requestor.

21. The method of claim 20, wherein the transferring includes one or more interactions over the network involving the delegator.

22. The method of claim 20, wherein the desired article is a physical article and transferring the desired article comprises shipping the article to the recipient.

23. The method of claim 20, wherein the desired article is an electronic article and transferring the desired article comprises electronically transmitting the article to the requestor.

24. The method of claim 20, wherein transferring comprises updating one or more records indicating ownership of the desired article by the requestor.

25. The method of claim 18, wherein executing the transaction includes electronically transmitting payment information from the requestor to the delegate.

26. The method of claim 25, further including, subsequent to the executed transaction, processing the payment information received from the requestor in order to collect payment.

27. The method of claim 1 further including, subsequent to the executing, informing the delegator of the executed transaction.

28. An information management system comprising:
an automated delegator having full control over a dataset;
an automated delegate having authority over a subset of the dataset;
an automated requestor having modifications to the subset over which the delegate has authority; and
wherein the automated delegator implements the requestor's modifications only after being authorized to do so by the delegate.

29. A system comprising a primary data server, a first secondary data server, and a second secondary data server communicatively coupled to each other, wherein the primary data server comprises a core dataset and is programmed to operate at times in a first state and a second state, wherein while operating in the first state the primary data server modifies the core dataset in response to modification requests received from the second secondary data server even if such requests are not authorized by the first secondary data server, and while operating in the second state the primary data server does not modify the core dataset in response to modification requests received from the second secondary data server unless such requests are authorized by the first secondary data server.

30. The system of claim 29 wherein the primary data server is programmed, while operating in the second state, to respond to a request to modify the core dataset received from the second secondary data server by refusing to modify the core dataset and identifying the first secondary data server to the second secondary data server.

31. The system of claim 30 wherein the first secondary data server is programmed to provide an authorization to update the core dataset upon receipt of a request for such authorization from the second secondary server.

32. The system of claim 31 wherein the first secondary data server is programmed to provide the authorization to update to the core dataset to the second secondary data server, and the second secondary data server is programmed to subsequently provide the authorization to update the core dataset along with a request to update the core dataset to the primary data server.

33. The system of claim 31 wherein the first secondary data server is programmed to accept a request to modify the core dataset from the second secondary data server and to pass that request to modify the core dataset to the primary data server wherein the request to update the core dataset passed to the primary data server by the first secondary server is itself the authorization to update the core dataset.

34. The system of claim 30 wherein the second secondary data server is programmed to respond to the refusal and identification received from the primary data server by communicating its request to modify the core dataset tot he first secondary data server.

35. The system of claim 29 wherein the storage device comprises at least 2 physical storage units.

36. The system of claim 29 wherein the storage device comprises at least 1 terabyte.

37. The system of claim 29 wherein the core dataset comprises at least one record of a table of a relational database.

38. The system of claim 29 wherein the core dataset comprises one or more data files.

39. The system of claim 38 wherein at least one of the data files comprises image data.

40. The system of claim 29 wherein the authorization to modify the data item is dependent upon a time based protocol.

41. The system of claim 29 wherein the authorization to modify the data item is dependent a priority based protocol.

42. The system of claim 29 wherein the primary server comprises a data controller and a data storage device wherein both the controller and storage device are located within a common housing.

43. The system of claim 29 wherein the primary server comprises a data controller and a data storage device wherein the data storage device is located at least 1 km away from the data controller.

44. A system comprising:
a storage device having at least one data item;
a first processor programmed at times to operate in a first state and at other times to operate in a second state;
the first processor operating in the first state having control over requests to modify the data item;
a second processor sends a request to update to the first processor;
the first processor operating in the second state directs the second processor to obtain an authorization to update from a third processor.

45. The system of claim 44 wherein the third processor is programmed to provide the authorization to update to the first processor.

46. The system of claim 44 wherein the third processor is programmed to update the data item.

47. The system of claim 44 wherein the third processor is programmed to provide the authorization to update to the second processor.

48. The system of claim 47 wherein the second processor is programmed to update the data item.
